(19) United States
(12) Patent Application Publication
(10) Pub. No.: US 2015/0045958 A1
(43) Pub. Date: Feb. 12, 2015

(54) TIME CHART CREATION APPARATUS, CONTROLLER, MACHINE ELEMENT CONTROL SYSTEM, TIME CHART CREATION METHOD, AND INFORMATION STORAGE MEDIUM

(71) Applicant: KABUSHIKI KAISHA YASKAWA DENKI, Kitakyushu-shi (JP)

(72) Inventors: Takeshi NAGATA, Kitakyushu-shi (JP); Yoshitomo Shiramizu, Kitakyushu-shi (JP); Kenichi Hirose, Kitakyushu-shi (JP); Naoki Shiromoto, Kitakyushu-shi (JP)

(73) Assignee: KABUSHIKI KAISHA YASKAWA DENKI, Kitakyushu-shi (JP)

(21) Appl. No.: 14/524,354

(22) Filed: Oct. 27, 2014

Related U.S. Application Data
(63) Continuation of application No. PCT/JP2013/060758, filed on Apr. 9, 2013.

(30) Foreign Application Priority Data
Apr. 27, 2012 (JP) PCT/JP2012/061492

(51) Int. Cl. G05B 15/02

(52) U.S. Cl. CPC G05B 15/02
USPC 700/275

(57) ABSTRACT

A time chart creation apparatus for providing control data to a machine control system controlling an operation conversion apparatus includes circuitry which receives an input of a travel distance of a mechanical element of the operation conversion apparatus, receives an input of one or more of an acceleration time, a deceleration time, an acceleration rate and a deceleration rate of the mechanical element of the operation conversion apparatus, calculates a time chart based on the travel distance and one or more of the acceleration time, the deceleration time, the acceleration rate and the deceleration rate such that the time chart includes a velocity transition of the mechanical element of the operation conversion apparatus, and outputs the control data to the machine control system, which controls the mechanical element of the operation conversion apparatus based on the time chart represented in the control data.

### CROSS-REFERENCE TO RELATED APPLICATIONS

The present application is a continuation of and claims the benefit of priority to International Patent Application PCT/JP2013/060758, filed Apr. 9, 2013, which is based upon and claims the benefit of priority to International Patent Application PCT/JP2012/061492, filed Apr. 27, 2012. The entire contents of these applications are incorporated herein by reference.

### BACKGROUND OF THE INVENTION

1. Field of the Invention

This invention relates to a time chart creation apparatus, a controller, a mechanical element control system, a time chart creation method, and an information storage medium.

2. Description of Background Art

Japanese Patent Application Laid-open No. 2003-228403 describes a system in which a personal computer is used to create a time chart that indicates an operation pattern of an actuator, such as a cylinder, which is automatically operated based on the created time chart.

Japanese Patent Application Laid-open No. 07-191717 describes a control program automatic creation apparatus having a function of automatically creating a ladder program that is directly executed by a programmable controller from a time chart. The ladder program describes the operation of an arm, which is an n-state control target device, that moves to a designated position based on the time chart, and device control information that includes basic parameters including the maximum movement velocity, acceleration time, deceleration time, and the like, and operation parameters including the movement velocity and the like, which are stored in a device control information storage unit.

Japanese Patent Application Laid-open No. 2003-84838 describes utilization of a trapezoidal velocity command that is generated by changing the acceleration time, constant-velocity time, and deceleration time based on an intended movement distance when generating a target track for causing a positioning control target to arrive at a target position from a current position.

The entire contents of these publications are incorporated herein by reference.

### SUMMARY OF THE INVENTION

According to one aspect of the present invention, a time chart creation apparatus for providing control data to a machine control system controlling an operation conversion apparatus includes circuitry which receives an input of a travel distance of a mechanical element of the operation conversion apparatus, receives an input of one or more of an acceleration time, a deceleration time, an acceleration rate and a deceleration rate of the mechanical element of the operation conversion apparatus, calculates a time chart based on the travel distance and one or more of the acceleration time, the deceleration time, the acceleration rate and the deceleration rate such that the time chart includes a velocity transition of the mechanical element of the operation conversion apparatus, and outputs the control data to the machine control system, which controls the mechanical element of the operation conversion apparatus based on the time chart represented in the control data.

According to another aspect of the present invention, a machine control system for controlling an operation conversion apparatus includes a controller which controls a mechanical element of the operation conversion apparatus connected to the controller based on a time chart represented in control data. The controller receives the time chart from a time chart creation apparatus including circuitry which receives an input of a travel distance of the mechanical element of the operation conversion apparatus, receives an input of one or more of an acceleration time, a deceleration time, an acceleration rate and a deceleration rate of the mechanical element of the operation conversion apparatus, calculates the time chart based on the travel distance and one or more of the acceleration time, the deceleration time, the acceleration rate and the deceleration rate such that the time chart includes a velocity transition of the mechanical element of the operation conversion apparatus, and outputs the control data to the controller which controls the mechanical element of the operation conversion apparatus based on the time chart represented in the control data.

According to yet another aspect of the present invention, a method of creating a time chart for providing control data to a machine control system controlling an operation conversion apparatus includes receiving a user input of a travel distance of a mechanical element of the operation conversion apparatus, receiving an input of one or more of an acceleration time, a deceleration time, an acceleration rate and a deceleration rate of the mechanical element of the operation conversion apparatus, calculating a time chart based on the travel distance and one or more of the acceleration time, the deceleration time, the acceleration rate and the deceleration rate such that the time chart includes a velocity transition of the mechanical element of the operation conversion apparatus, and outputting the control data to the machine control system that controls the mechanical element of the operation conversion apparatus based on the time chart represented in the control data.

According to still another aspect of the present invention, a non-transitory computer readable medium having stored thereon a program that when executed by a computer causes the computer to execute a method of creating a time chart for providing control data to a machine control system controlling an operation conversion apparatus, and the method includes receiving an input of a travel distance of a mechanical element of the operation conversion apparatus, receiving an input of one or more of an acceleration time, a deceleration time, an acceleration rate and a deceleration rate of the mechanical element of the operation conversion apparatus, calculating a time chart based on the travel distance and one or more of the acceleration time, the deceleration time, the acceleration rate and the deceleration rate such that the time chart includes a velocity transition of the mechanical element of the operation conversion apparatus, and outputting the control data to the machine control system that controls the mechanical element of the operation conversion apparatus based on the time chart represented in the control data.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a function block diagram of a time chart creation apparatus according to an embodiment of the present invention;

FIG. 2 is a block diagram illustrating a physical configuration of the time chart creation apparatus according to the embodiment of the present invention;

FIG. 3 illustrates a utilization example of the time chart creation apparatus according to the embodiment of the present invention;

FIG. 4 illustrates an operation example of a machine control system;

FIG. 5 shows an example of a time chart edit screen;

FIG. 6 shows an example of a window displayed on the time chart edit screen;

FIG. 7 schematically shows an example of chart data;

FIG. 8 schematically shows an example of link data;

FIG. 9 is a flow chart illustrating processing performed by the time chart creation apparatus during editing of a time chart relating to a servo unit;

FIG. 10A shows a time chart relating to a servo unit;

FIG. 10B shows a time chart relating to a servo unit;

FIG. 11A shows a time chart relating to a servo unit;

FIG. 11B shows a time chart relating to a servo unit; and

FIG. 12 shows an example of the time chart edit screen.

### DETAILED DESCRIPTION OF THE EMBODIMENTS

The embodiments will now be described with reference to the accompanying drawings, wherein like reference numerals designate corresponding or identical elements throughout the various drawings.

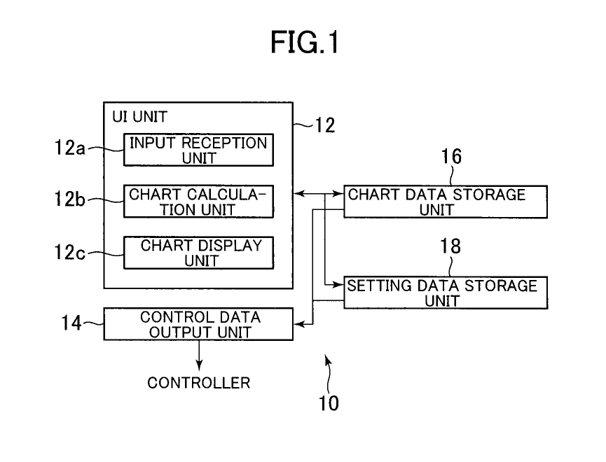

FIG. 1 is a function block diagram of a time chart creation apparatus according to an embodiment of the present invention. A time chart creation apparatus 10 illustrated in FIG. 1 is configured from a personal computer or some other type of computer that includes a main unit configured around a central processing unit (CPU), a display that uses a flat panel and the like, and various input devices such as a keyboard and a pointing device, and a program that is executed by such a computer. The various function blocks illustrated in FIG. 1 are realized by executing this program. The program may be stored in a computer-readable information storage medium, such as various types of optical disc or semiconductor memory, and installed on the computer from that medium. Alternatively, the program may be downloaded to the computer from various types of information communication network, such as the Internet.

The time chart creation apparatus 10 is an apparatus that supports the creation by the user of an arbitrary program relating to a machine control system. The machine control system controls a mechanical element by executing a program, which being control data describing control contents. Specifically, the time chart creation apparatus 10 supports the creation of a time chart (operation pattern diagram) on a computer screen. Further, the time chart creation apparatus 10 converts the thus-created time chart into control data that can be executed by a controller included in the machine control system. The converted control data is transferred to the machine control system and executed by the machine control system.

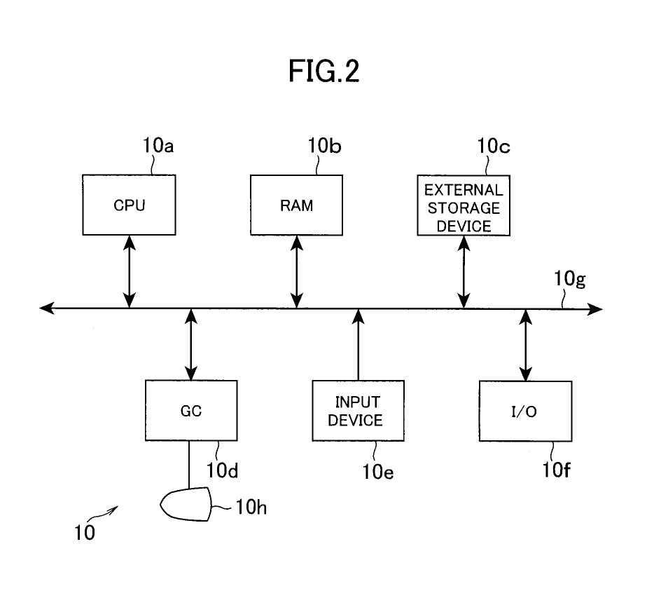

FIG. 2 is a block diagram showing a physical configuration of the time chart creation apparatus 10. The time chart creation apparatus 10 is a common computer, in which a CPU (10a), a random-access memory (RAM) (10b), an external storage device (10c), a graphics controller (GC) (10d), an input device (10e), and an input/output (I/O) (10f) are connected to one another by a data bus (10g) so that the devices can exchange electric signals therebetween. The external storage device (10c) is a device capable of statically recording information, such as a hard disk drive (HDD) or a solid state drive (SSD). Further, signals from the GC (10d) are output and displayed as an image on a monitor (10h), such as a cathode ray tube (CRT) or a so-called flat panel display, by which the user visually recognizes the image. The input device (10e) is a device, such as a keyboard, a mouse, or a touch panel, by which the user inputs information. The I/O (10f) is an interface that allows the time chart creation apparatus 10 to exchange information with an external device. In this embodiment, the external device is a controller 100.

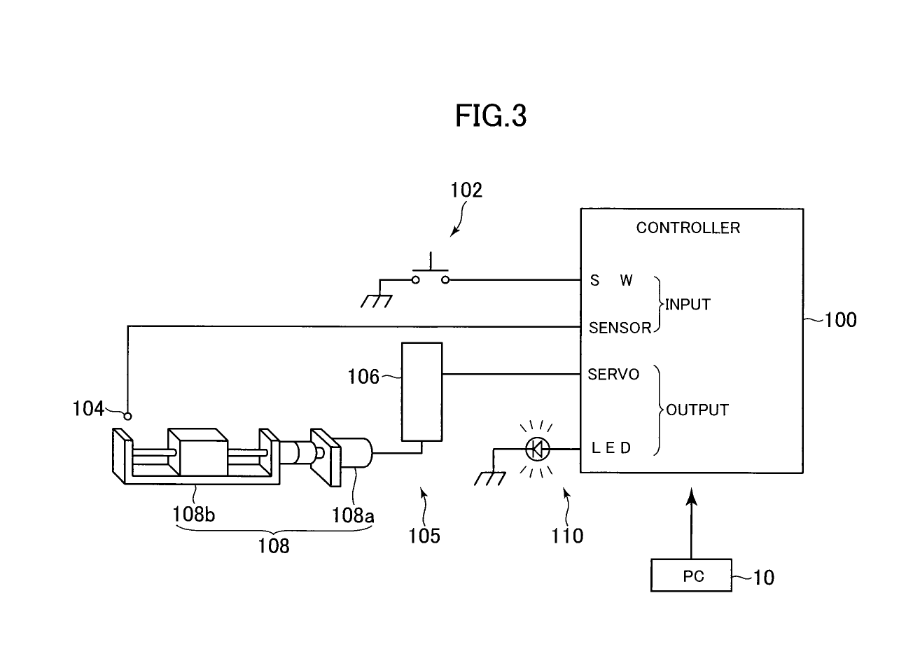

FIG. 3 illustrates a utilization example of the time chart creation apparatus 10. FIG. 3 illustrates a state in which the time chart creation apparatus 10 configured from a personal computer is connected to the controller 100 of a machine control system. The machine control system illustrated as an example includes this controller 100, which is a programmable logic controller (PLC) or the like, which includes a microprocessor that enables the controller 100 to control a connection device by executing a program. Here, the controller 100 is connected to a push switch 102, a sensor 104, a servo unit 105, and an LED 110. The servo unit 105 includes a servo amplifier 106 and a mechanism 108. The mechanism 108 is configured from a servo motor (108a) and an operation conversion mechanism (108b), which is a mechanism that converts a rotational operation of the servo motor (108a) into a linear operation. The servo amplifier 106 receives a movement directive from the controller 100, and drives and controls the servo motor (108a) based on that directive. The operation conversion mechanism (108b) includes a ball screw driven by the servo motor (108a) and a slider that moves linearly in an extension direction of another ball screw that is coupled to the ball screw. The sensor 104 is arranged at an end portion of the ball screw so that when the slider reaches the end portion of the ball screw, an output from the sensor 104 indicating that the slider has been detected is input to the controller 100.

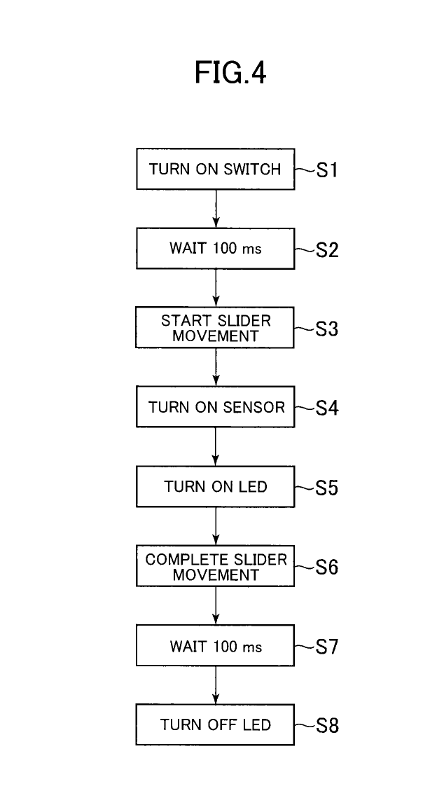

For ease of understanding, an example is now described below in which the time chart creation apparatus 10 is used to create a time chart for causing the machine control system illustrated in FIG. 3 to perform the following operation. In other words, in the machine control system illustrated as an example, as illustrated in FIG. 4, when the push switch 102 is pressed (S1), the operation conversion mechanism (108b) waits 100 ms (S2), and then starts to move the slider (S3). The slider reaches the end portion of the operation conversion mechanism (108b), and a signal indicating that the slider has been detected is output from the sensor 104 (S4). When this signal is output, the controller 100 turns on the LED 110 (S5). Then, when the slider stops (S6), the operation conversion mechanism 108b waits 100 ms (S7), and then turns off the LED 110 (S8).

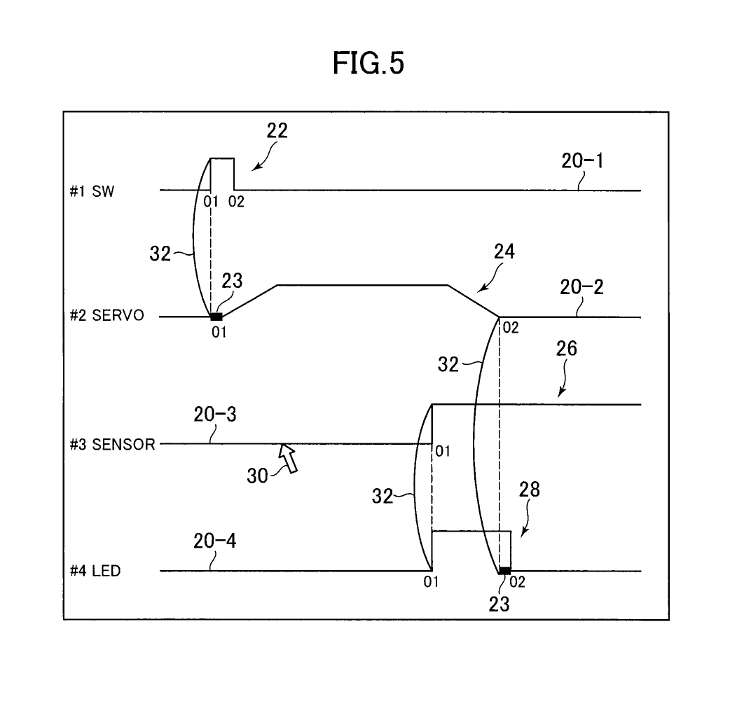

FIG. 5 illustrates an example of a time chart edit screen displayed on a display of the time chart creation apparatus 10. The time charts shown on the screen are for causing the machine control system to execute the operation illustrated in FIG. 4. This time chart shows, in order from the top of the screen, a time chart 20-1 indicating an input signal from the push switch 102, which is a unit 1, a time chart 20-2 indicating an operation pattern of the servo unit 105, which is a unit 2, a time chart 20-3 indicating an input signal from the sensor 104, which is a unit 3, and a time chart 20-4 indicating an output signal to the LED 110, which is a unit 4. The number of time charts on the edit screen can be optionally increased or decreased based on the number of units included in the machine control system. Further, the unit type (input unit, output unit, or servo unit) corresponding to each time chart can be set in the time chart creation apparatus 10.

The horizontal axis of the time charts 20-1 to 20-4 is a time axis. However, the meaning of the vertical axis differs depending on the type of unit. In other words, the vertical axis of the time charts 20-1, 20-3, and 20-4, which are time charts for an input unit or an output unit, represents the level of an input signal or an output signal. The vertical axis of the time chart 20-2 for the servo unit 105 represents the movement velocity of the slider, which is a mobile body being driven by the servo unit 105. Here, the term “input unit” is defined as a device that inputs a signal level of any one of high and low to the controller 100 as an input signal, and the term “output unit” is defined as a device that receives a signal level of any one of high and low from the controller 100 as an output signal. Further, a device for driving a mobile body, like the servo unit 105, is called “mechanical element”.

The time chart 20-1 for the push switch 102 includes a waveform 22 that rises when the push switch 102 is pressed and falls when the pressing of the push switch 102 is released, which corresponds to Step S1 of FIG. 4. Further, the time chart 20-2 for the servo unit 105 includes an identification line 23 indicating a wait of 100 ms, which corresponds to Step S2 of FIG. 4. In addition, the time chart 20-2 also includes a trapezoidal waveform 24 indicating acceleration at a predetermined acceleration rate, movement at a constant velocity, and deceleration at a predetermined deceleration rate, which corresponds to Steps S3 and S6 of FIG. 4. The time chart 20-3 for the sensor 104 includes a waveform 26 that rises at a position overlapping a right edge portion of the waveform 24, which corresponds to Step S4 of FIG. 4. Further, a waveform 28 included in the time chart 20-4 for the LED 110 rises in synchronization with the rise of the waveform 26 relating to the sensor 104, which corresponds to Step S5 of FIG. 4. In addition, the time chart 20-4 includes an identification line 23 indicating a wait of 100 ms from the timing of the right edge of the waveform 24 relating to the servo unit 105, which corresponds to Step S7 of FIG. 4. Still further, the waveform 28 falls at the timing of the right edge of the identification line 23, which corresponds to Step S8 of FIG. 4. An identification number such as “01” or “02” is indicated at the zero cross timing in each of the time charts.

Further, during operation of the machine control system illustrated in FIG. 4, the 100 ms wait is started in Step S2 based on a condition of the push switch 102 being pressed in Step S1. Consequently, on the screen illustrated in FIG. 5, between the timing of the rise of the waveform 22 included in the time chart 20-1 for the push switch 102 and the left edge timing of the identification line 23 indicating the 100 ms wait, a curved condition line 32 connecting the two timing points is shown.

Similarly, during operation of the machine control system illustrated in FIG. 4, the LED 110 is turned on in Step S5 based on a condition of the output of the sensor 104 in Step S4. Consequently, on the screen illustrated in FIG. 5, between the timing of the rise of the waveform 26 included in the time chart 20-3 for the sensor 104 and the timing of the rise of the waveform 28 included in the time chart 20-4 for the LED 110, a curved condition line 32 connecting the two timing points is also shown. In addition, during operation of the machine control system illustrated in FIG. 4, the 100 ms wait is started in Step S7 based on a condition of the completion of movement of the slider in Step S6. Consequently, on the screen illustrated in FIG. 5, between the right edge timing (timing at which movement is completed) of the waveform 24 included in the time chart 20-2 and the left edge timing of the identification line 23 indicating the 100 ms wait, a curved condition line 32 connecting the two timing points is also shown.

In the screen illustrated in FIG. 5, the shape of the timing charts 20-1 to 20-4 can be freely edited by the user using a pointing device, such as a mouse, and a numerical value input device, such as a keyboard and a numeric keypad. For example, the time charts (20-1, 20-3, 20-4) of units (1, 3, 4), which are input and output units, can be made to rise or fall by moving a cursor 30 with the pointing device, and designating an arbitrary position on the time chart with the cursor 30. At this time, regarding the time chart 20-1 of the unit 1, which is an input unit, an input reception unit 12a functions as an input change timing reception unit structured to receive the timing at which a change occurs in the input from the input unit.

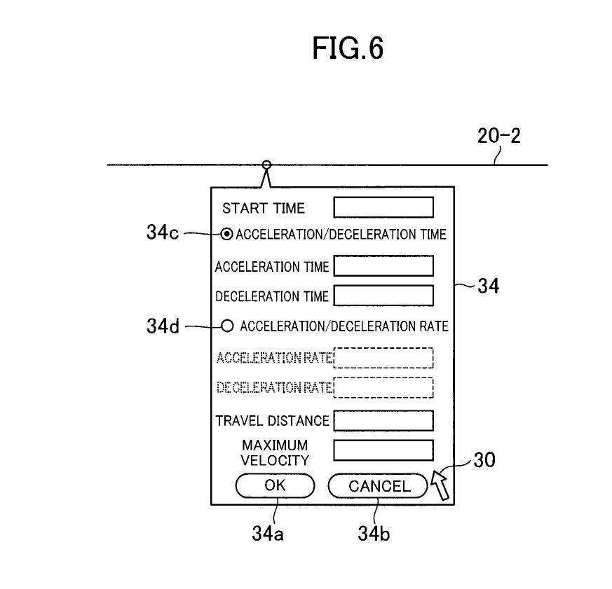

On the other hand, regarding the time chart 20-2 relating to the servo unit 105, when the start timing of the waveform 24 is designated by the cursor 30, a window 34 illustrated in FIG. 6 is displayed and superimposed over the time chart 20-2. The window 34 includes multiple numerical value input forms for inputting data to designate the details of the trapezoidal waveform 24. In other words, a slider movement start time, a slider acceleration time, a slider deceleration time, a slider travel distance, and a slider maximum velocity are input in the window 34 by a numerical value input device such as a keyboard or a numeric keypad. The slider movement start time corresponds to the left edge position of the waveform 24. The slider acceleration time corresponds to the length in the horizontal direction of the upward-sloping section of the waveform 24, and the slider deceleration time corresponds to the length in the horizontal direction of the downward-sloping section of the waveform 24. The slider travel distance corresponds to the area of the waveform 24, and the slider maximum velocity corresponds to the height of the trapezoidal waveform 24. By inputting the numerical values for those pieces of information, and clicking on an OK button (34a) included in the window 34, the time chart creation apparatus 10 specifies the shape of the waveform 24 from the input numerical values, and updates the shape of the time chart 20-2. The window 34 can be closed by clicking on a cancel button (34b) included in the window 34.

Further, on the screen illustrated in FIG. 5, the above-mentioned condition line 32 can be added by using the pointing device to designate with the cursor 30 a timing on an arbitrary time chart that corresponds to a drive event and a timing on a different arbitrary time chart that corresponds to a driven event. Examples of the timing corresponding to a drive event that can be designated include the rising timing and the falling timing of a time chart relating to the input units, such as the push switch 102 and the sensor 104, and a movement completion timing of the servo unit 105. Examples of the timing corresponding to a driven event that can be designated include the rising timing of a time chart relating to an output unit such as the LED, and a movement start timing of the servo unit 105. When adding the condition line 32, a window (not shown) is displayed so that the wait time can be input. By inputting the wait time with a numerical value input device, a wait time is inserted before the start of the driven event, and the identification line 23 is displayed on the screen. In the time chart creation apparatus 10, control data for starting the driven event is generated from the time charts based on a condition of the arrival of a timing corresponding to a drive event, and the generated control data is transferred to the controller 100. Further, if a wait time has been input, control data indicating a wait before the start of the driven event corresponding to the time that has been input is generated from the time charts, and the generated control data is transferred to the controller 100.

When receiving the inputs of the condition line 32 and the identification line 23, the input reception unit 12a functions as an association reception unit structured to receive an input of an association between a timing at which a change occurs in an input from an input unit and a timing at which the mechanical element indicated by the time chart starts to move.

Returning to FIG. 1, the time chart creation apparatus 10 functionally includes, as illustrated in FIG. 1, a user interface (UI) unit 12, a control data output unit 14, a chart data storage unit 16, and a setting data storage unit 18. The UI unit 12 includes the input reception unit (12a), a chart calculation unit (12b), and a chart display unit (12c). Examples of the input reception unit (12a) include a travel distance reception unit, an acceleration/deceleration time reception unit, an acceleration/deceleration rate reception unit, a maximum velocity reception unit, an input change timing reception unit, an association reception unit, and an output-associated setting unit. The input reception unit (12a) receives various types of numerical data from the numerical value input device, receives a designation of a timing on a time chart from the pointing device, and receives various instructions regarding the user's intentions.

Especially, as illustrated in FIG. 6, regarding the servo unit 105, the input reception unit (12a) receives inputs of a slider travel distance, a slider acceleration time and deceleration time or a slider acceleration rate and deceleration rate, and a slider maximum velocity. In addition, as described above, the input reception unit (12a) receives inputs for the condition line 32 and the identification line 23. The chart calculation unit (12b), which is an example of a time chart calculation unit, calculates the shape of each time chart based on the inputs received by the input reception unit (12a). Especially, regarding the servo unit 105, based on the input slider travel distance, acceleration time, deceleration time, acceleration rate, deceleration rate, and/or maximum velocity, the chart calculation unit (12b) calculates a time chart indicating a velocity transition in which the slider movement velocity gradually increases and then gradually decreases. Specifically, the chart calculation unit (12b) calculates a waveform 24 in which the velocity gradually rises and then gradually falls so that the area of the region surrounded by the waveform 24 and the time axis has a designated travel distance.

Here, if the designated travel distance is sufficiently large, the slider is accelerated to its maximum velocity, and then operates at a constant velocity (constant-velocity operation). If a time chart including this constant-velocity operation is referred to as a first time chart, this first time chart is the trapezoidal waveform 24 for controlling the slider to perform, in order, an acceleration operation, in which the slider accelerates for the designated acceleration time at a predetermined acceleration rate until reaching the designated maximum velocity or accelerates at the designated acceleration rate until reaching the designated maximum velocity, a constant velocity movement in which the slider moves at the designated maximum velocity, and a deceleration operation in which the slider decelerates for the designated deceleration time at a predetermined deceleration rate until stopping or decelerates at the designated deceleration rate until stopping.

In contrast, if the designated travel distance is small, the slider decelerates without being accelerated to its maximum velocity. If this operation that shifts to deceleration after acceleration is referred to as a second time chart, this second time chart is the waveform 24 of a triangular waveform, in which after an acceleration operation of accelerating at a predetermined acceleration rate for the designated acceleration time or accelerating at the designated acceleration rate, the slider is controlled to perform a deceleration operation of decelerating at a predetermined deceleration rate for the designated deceleration time or decelerating at the designated deceleration rate. Therefore, the chart calculation unit (12b) selectively calculates the first time chart and the second time chart based on the travel distance of the slider.

With the time chart creation apparatus 10 according to this embodiment, a waveform based on the operation of the actual mechanical element can be calculated. Especially, in this time chart creation apparatus, for example, if the movement distance has been designated, multiple waveforms, namely, multiple types of time chart (here, the first time chart and the second time chart) that reflect the operations of an actual mechanical element, can be selectively calculated based on the magnitude of the movement distance. Therefore, time charts reflecting the operation of an actual mechanical element can be created, and consequently, the application range of operations that can be created by the time chart creation apparatus can be significantly enlarged.

In FIG. 6, the input reception unit (12a) displays the window 34 as a GUI, and while the chart calculation unit (12b) is calculating the waveform 24 of the slider, selects whether to use the acceleration time and the deceleration time, or to use the acceleration rate and the deceleration rate. In other words, whether the acceleration time and the deceleration time are used or the acceleration rate and the deceleration rate are used is selected by selecting any one of a radio button (34c) and a radio button (34d). Further, as illustrated in FIG. 6, if the radio button (34c) is selected, the entry fields for the acceleration time and the deceleration time are activated, which enables the acceleration time and the deceleration time to be input. On the other hand, the entry fields for the acceleration rate and the deceleration rate are disabled so that the acceleration rate and the deceleration rate cannot be input. If the radio button (34d) is selected, the opposite operation is performed. Although in FIG. 6 the fact that the fields are disabled is represented by a dotted line, on an actual window 34, this fact can also be indicated by graying out and the like. Further, the window 34 illustrated in FIG. 6 is one example of the GUI, and other designs may also be employed. In addition, although in this embodiment, whether to use the acceleration time and the deceleration time or to use the acceleration rate and the deceleration rate can be selected for each waveform (i.e., for each of the first time chart and the second time chart), this selection can also be made for each servo unit 105, which is a mechanical element.

Further, in the window 34 illustrated in FIG. 6, the acceleration time and deceleration time entry fields are an example of an acceleration/deceleration time reception unit realized by the input reception unit (12a), the acceleration rate and deceleration rate entry fields are an example of an acceleration/deceleration rate reception unit realized by the input reception unit (12a), the travel distance entry field is an example of the travel distance reception unit realized by the input reception unit (12a), and the maximum velocity entry field is an example of the maximum velocity reception unit realized by the input reception unit 12a.

If the acceleration time and the deceleration time or the acceleration rate and the deceleration rate are to be set the same, the user only needs to input any one of those parameters. Further, although the maximum velocity can be input by the user, a fixed value can also be stored by the time chart creation apparatus 10 as the maximum velocity, or the maximum velocity may be acquired from a different device such as the servo amplifier 106. The term “deceleration rate” as used herein means the acceleration rate in the direction in which velocity decreases (i.e., negative acceleration). When the expressions “accelerate at a predetermined acceleration rate” and “decelerate at a predetermined deceleration rate” are used, those expressions not only include cases in which the acceleration rate during acceleration and the deceleration rate during deceleration are held constant, but also cases in which the acceleration rate and the deceleration rate change smoothly or in steps so that the acceleration rate during acceleration and the deceleration rate during deceleration are a predetermined acceleration rate and a predetermined deceleration rate, respectively as a whole. For example, those expressions include a case in which the acceleration rate and the deceleration rate change along a so-called S-shaped curve. The chart display unit (12c) displays the time charts calculated by the chart calculation unit (12b) on a display.

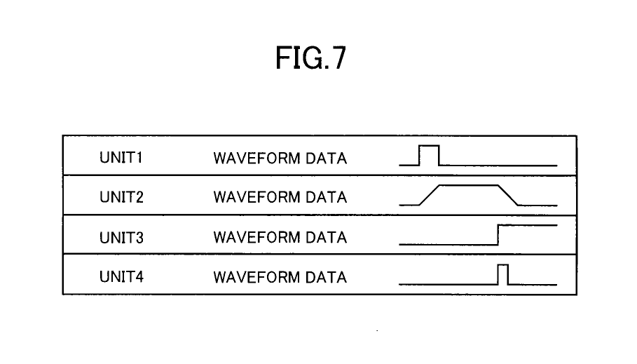

As illustrated in FIG. 7, the chart data storage unit 16 stores data that is created by the user to specify the shape of the time chart of each unit. This data may be data that specifies a vertex array of each time chart, for example. Further, as described above, an identification number associated with the zero cross timing in each time chart is also stored.

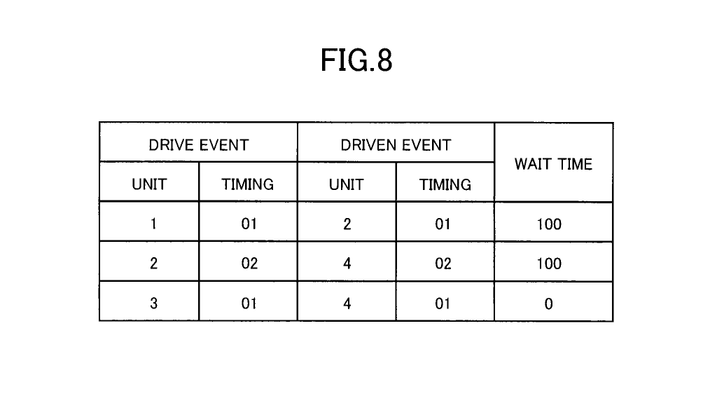

The chart data storage unit 16 also stores link data that is schematically shown in FIG. 8. The link data is data specifying the above-mentioned condition line 32 and identification line 23. When the timing relating to a drive event and a driven event has been designated and a wait time is input as needed by the user, the data specifying those matters is stored in the chart data storage unit 16. As shown in FIG. 8, the timing relating to a drive event and a driven event may be specified by a unit number and an identification number of the zero cross timing in the time chart.

The setting data storage unit 18 stores various pieces of information relating to the machine control system. Those pieces of information may be input by the user using the numerical value input device and the pointing device. Further, a part or all of this information may be downloaded from another computer via an information communication network, such as the Internet. Here, the setting data includes data about the type of each unit for which a time chart is stored in the chart data storage unit 16. Further, allocation data indicating which control port of the controller 100 each unit corresponds to is also included in the setting data. In addition, detailed information relating to the servo unit 105, such as a conversion rate between rotary motion of the servo motor (108a) and linear motion of the slider, is also included in the setting information.

The control data output unit 14 generates control data that can be interpreted and executed by the controller 100 based on the time chart data and link data for each unit stored in the chart data storage unit 16, and allocation data and a conversion rate stored in the setting data storage unit 18. Further, the control data output unit 14 transfers the generated control data to the controller 100. The control data includes data instructing output units, such as the LED 110, and the servo unit 105 to perform a designated operation when a designated time point arrives based on the time chart. Further, especially for an instruction that is issued based on link data, the control data includes data for monitoring the arrival of the timing relating to a drive event, and starting the driven event when the timing arrives, or as needed, after a designated time period has elapsed.

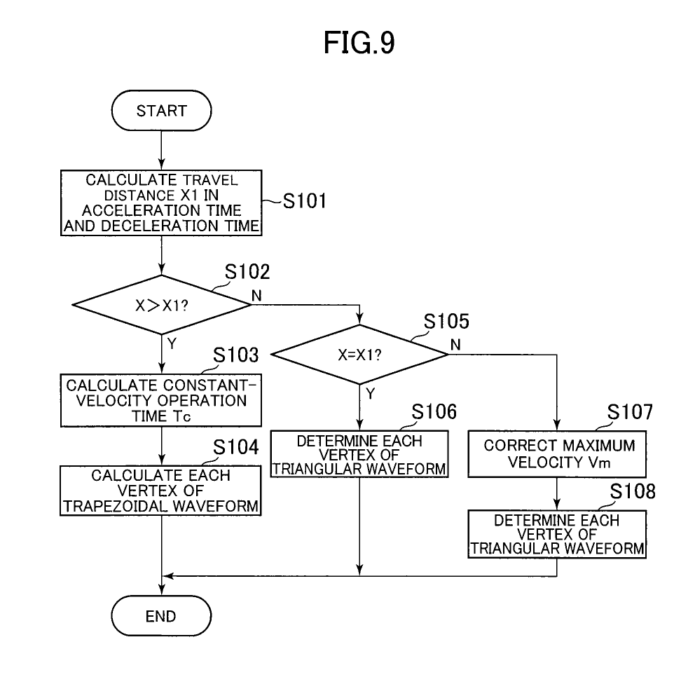

Here, among the processes performed by the chart calculation unit 12b illustrated in FIG. 1, the processing for calculating the waveform relating to the servo unit 105 is described in particular. FIG. 9 is a flow diagram showing processing performed by the time chart creation apparatus for editing the time chart relating to a servo unit. FIG. 9 is executed when the OK button (34a) included in the window 34 illustrated in FIG. 6 is clicked. Further, the designated start time is represented by ts, the designated travel distance (corresponding to the area) is represented by X, the designated acceleration time is represented by Ta, the designated deceleration time is represented by Td, the designated acceleration rate is represented by Aa, the designated deceleration rate is represented by Ad, and the designated maximum velocity is represented by Vm. In addition, a constant-velocity operation time, which is the movement time at the maximum velocity (Vm) calculated from those values, is represented by Tc.

As illustrated in FIG. 9, in this processing, first, a travel distance X1 of the slider for the acceleration time Ta and the deceleration time Td is calculated based on the following expression (1) or (2) (S101). Expression (1) is employed when the designated acceleration time and deceleration time are used, and expression (2) is employed when the designated acceleration rate and deceleration rate are used.

X1=Vm×(Ta+Td)/2 (1)

X1=Vm²×(Aa⁻¹+Ad⁻¹)/2 (2)

Next, the travel distance (X) and the travel distance (X1) are compared with each other (S102). If the travel distance (X) is larger, the waveform generated by this processing has a trapezoidal shape, and hence the chart calculation unit (12b) calculates the first time chart. If the travel distance (X) is smaller, the waveform generated by this processing has a triangular shape, and hence the chart calculation unit (12b) calculates the second time chart.

If the first time chart is to be calculated, the chart calculation unit (12b) calculates the constant-velocity operation time (Tc) based on the following expression (3) (S103).

Tc=(X−X1)/Vm (3)

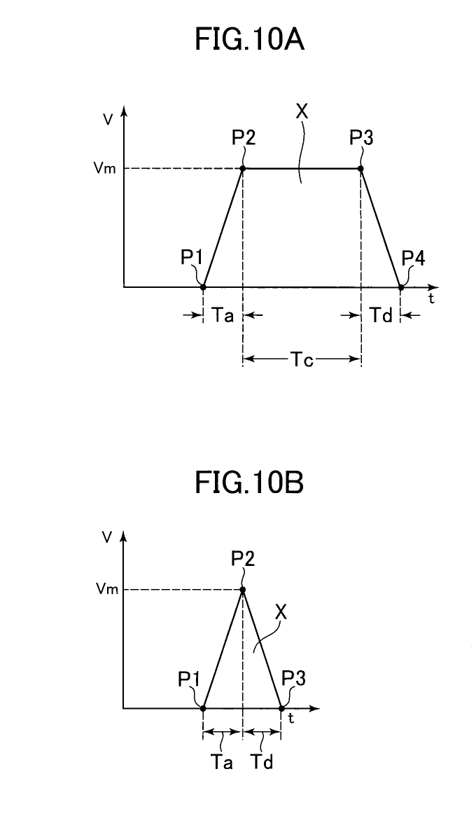

If the shape and respective vertices of the generated first time chart are the ones shown in FIG. 10A, the coordinates (t1, V1) to (t4, V4) of the respective vertices P1 to P4 of the trapezoid are calculated based on the following expressions (4) to (11) when the designated acceleration time and deceleration time are used, and are calculated based on the following expressions (12) to (19) when the designated acceleration rate and deceleration rate are used (S104).

t1=ts (4)

V1=0 (5)

t2=ts+Ta (6)

V2=Vm (7)

t3=ts+Ta+Tc (8)

V3=Vm (9)

t4=ts+Ta+Tc+Td (10)

V4=0 (11)

t1=ts (12)

V1=0 (13)

t2=ts+Vm/Aa (14)

V2=Vm (15)

t3=ts+Vm/Aa+Tc (16)

V3=Vm (17)

t4=ts+Vm/Aa+Tc+Vm/Ad (18)

V4=0 (19)

On the other hand, in Step S102, if the travel distance (X) is not larger than the travel distance (X1), in order to generate the second time chart, first, the chart calculation unit (12b) determines whether the travel distance (X) is equal to the travel distance (X1) (S105). If the travel distance (X) is equal to the travel distance (X1), the coordinates (tr1, Vr1) to (tr3, Vr3) of the respective vertices P1 to P3 of a triangular waveform in which the constant-velocity operation time (Tc) is zero, namely, the waveform shown in FIG. 10B, are calculated based on the following expressions (20) to (25) when the designated acceleration time and deceleration time are used, and are calculated based on the following expressions (26) to (31) when the designated acceleration rate and deceleration rate are used (S106).

tr1=ts (20)

Vr1=0 (21)

tr2=ts+Ta (22)

Vr2=Vm (23)

tr3=ts+Ta+Td (24)

Vr3=0 (25)

tr1=ts (26)

Vr1=0 (27)

tr2=ts+Vm/Aa (28)

Vr2=Vm (29)

tr3=ts+Vm/Aa+Vm/Ad (30)

Vr3=0 (31)

Further, if the travel distance (X) is not equal to the travel distance (X1) in Step S105, the maximum velocity (Vm) is corrected (S107). Specifically, the maximum velocity (Vm) is corrected so that when the slider is moved based on a triangular waveform formed from the designated acceleration time (Ta) and deceleration time (Td) or the designated acceleration rate (Aa) and deceleration rate (Ad), the travel distance is equal to the designated travel distance (X). The corrected maximum velocity (Vm′) is determined based on the following expression (32) when the designated acceleration time and deceleration time are used, and is determined based on the following expression (33) when the designated acceleration rate and deceleration rate are used.

Vm′=2×X/(Ta+Td) (32)

Vm′=[2×X/(Aa⁻¹+Ad⁻¹)]^{1/2} (33)

Then, using the corrected maximum velocity (Vm′) instead of the maximum velocity (Vm), each vertex of the triangular waveform is determined (S108). The processing performed at this stage may be the same as the processing performed in S106. In other words, the coordinates (tr1, Vr1) to (tr3, Vr3) of the respective vertices P1 to P3 of the triangular waveform are calculated based on the above-mentioned expressions (20) to (25) when the designated acceleration time and deceleration time are used, and are calculated based on the above-mentioned expressions (26) to (31) when the designated acceleration rate and deceleration rate are used.

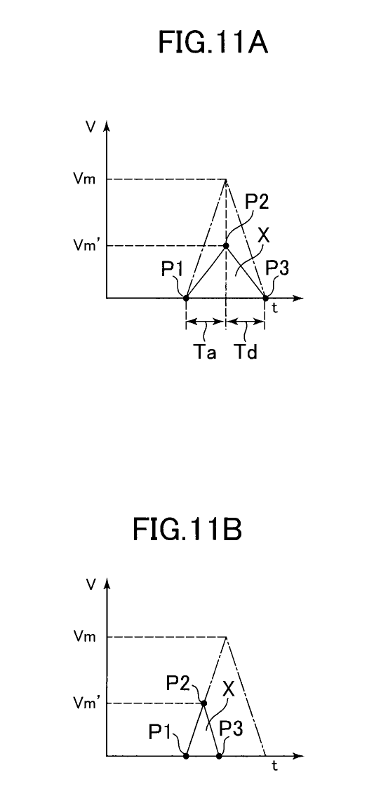

FIG. 11A shows a triangular waveform in which the corrected maximum velocity (Vm′) is determined instead of the maximum velocity (Vm) by using the designated acceleration time and deceleration time. Similarly, FIG. 11B shows a triangular waveform in which the corrected maximum velocity (Vm′) is determined instead of the maximum velocity (Vm) by using the designated acceleration rate and deceleration rate. In FIGS. 11A and 11B, the triangular waveform when Vm=Vm′ holds is shown with a dashed line for reference. As shown in FIG. 11A, when the designated acceleration time and deceleration time are used, in the obtained second time chart, the designated acceleration time (Ta) and deceleration time (Td) are reflected in the slider operation. On the other hand, as shown in FIG. 11B, when the designated acceleration rate and deceleration rate are used, in the obtained second time chart, the designated acceleration rate (Aa) and deceleration rate (Ad) are reflected in the slider operation. In other words, the slope during acceleration and deceleration of the triangular waveform remains as the designated value, and does not change.

If the maximum velocity (Vm) is to be corrected, user confirmation can be requested by, along with displaying the corrected maximum velocity (Vm′) on the screen, outputting a message such as “maximum velocity (Vm) needs to be changed”, for example, and setting and displaying the corrected maximum velocity (Vm′) in the numerical value entry field relating to the maximum velocity of the window 34. In this state, if the user again clicks on the OK button (34a), the processing of Step S108 of FIG. 9 is executed using the corrected maximum velocity (Vm′). The processing can also be configured so that if the corrected maximum velocity (Vm′) calculated in Step S107 is a minute value, an error message is output.

As described above, the time chart creation apparatus 10 according to this embodiment is employed in cases in which time charts are created using the designated acceleration time and deceleration time and in cases in which time charts are created using the designated acceleration rate and deceleration rate. Further, as described above with reference to FIG. 6, the time chart creation apparatus 10 can also select whether to use the designated acceleration time and deceleration time or to use the designated acceleration rate and deceleration rate.

When building a mechanical element control system, due to reasons such as limitations of a mechanical element, for example, there are cases in which it is desirable to move a mechanical element at a fixed acceleration rate and the like, or conversely, cases in which it is desirable to move a mechanical element for a fixed acceleration time and the like.

With the time chart creation apparatus 10 according to this embodiment, a time chart can be created that reflects a detailed velocity waveform for a mechanical element, such as the acceleration rate or the acceleration time. Consequently, even in cases in which it is desirable to move a mechanical element at a fixed acceleration rate, for example, a suitable time chart that meets such a demand can be created. Further, even in cases in which it is desirable to move a mechanical element for a fixed acceleration time, for example, a suitable time chart that meets such a demand can be created. In addition, by selecting which of those time charts that have different characteristics to create, detailed demands of the user can be coped with. Therefore, the time chart creation apparatus 10 according to this embodiment can further increase the flexibility of how to describe the operation of a mechanical element based on a time chart, and improve user-friendliness.

In the time chart illustrated in FIG. 5, although the operation of each unit and the interrelationship among those operations are shown in a form that is easy to visually understand, for an output unit whose operation is not determined in advance and that performs an operation by responding to a signal, the operation of such an output unit cannot be described properly. In the example illustrated in FIG. 5, an operation of the LED 110, which is the unit 4, is associated with the time chart 20-2 of the servo unit 105, which is the unit 2, and the time chart 20-3 of the sensor 104, which operates based on an operation of the servo unit 105. Once the operation of the servo unit 105 has been determined, the operation of the LED 110 can generally be predicted. In contrast, because the push switch 102, which is the unit 1, is human-operated, it is difficult to predict in advance what kind of operation is to be carried out. Consequently, for example, it is difficult to describe as a time chart an operation in which the LED 110 is turned on in association with an operation of the push switch 102.

Accordingly, with the time chart creation apparatus 10 according to this embodiment, output to a specific output unit (here, the LED 110) can be set (output-associated setting) so as to change in association with an input signal from an arbitrary input unit and/or an output signal to an arbitrary output unit.

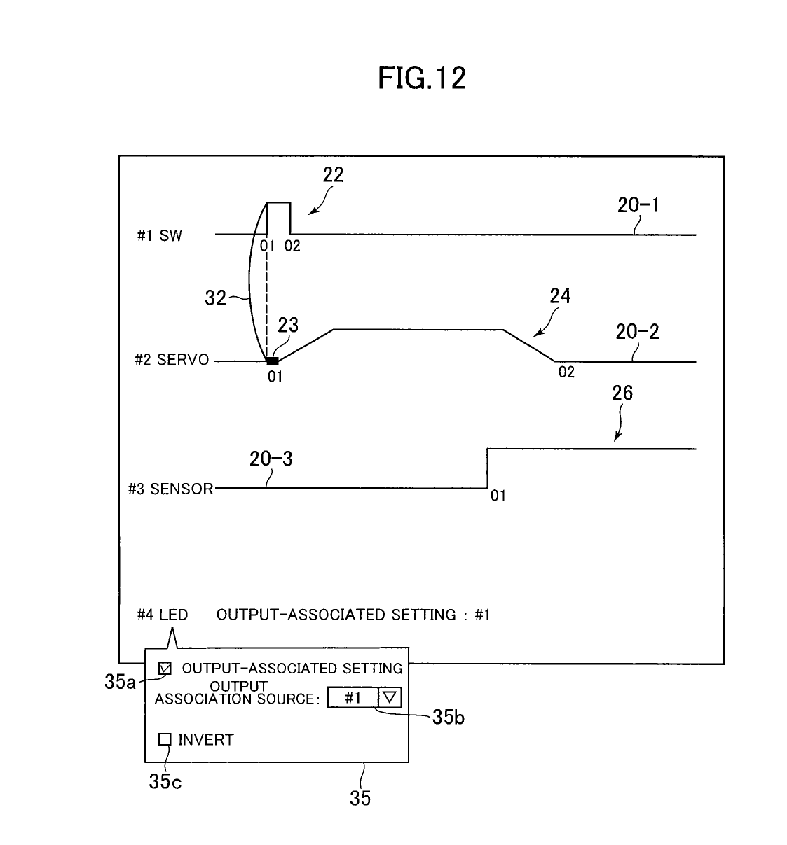

Specifically, as illustrated in FIG. 12, the input reception unit (12a) can display a window 35 as a GUI, for example, by selecting the LED 110, which is an output unit, and set an output-associated setting by checking a checkbox (35a). By checking the checkbox (35a) and selecting in an entry field (35b) an input unit or an output unit to be the target with which the output is to be associated (output association source), the output of that output unit changes in association with the selected input unit or output unit signal. In the example illustrated in FIG. 12, the push switch 102, which is the unit 1, is selected in the entry field (35b), and hence the LED 110 is turned on or turned off in association with the pressing or the release of the push switch 102. At this stage, the waveform of units for which the output-associated setting is set is not displayed on the time chart. A message notifying that an output-associated setting has been set and the output association source are displayed.

Regarding this point, by definition, a time chart is a diagram that describes the operation of a device on a time axis, which is different from a diagram that is mainly intended to describe a logic circuit, such as a ladder language. Consequently, no consideration is given to, for example, processing that is described by a logic operation in which an input signal is received at an arbitrary timing, and an output signal is output in association with the input signal. With the time chart creation apparatus 10 according to this embodiment, which includes the output-associated setting unit, even the time chart describing the operation of a device on a time axis enables such basic logic operation processing. Therefore, the level of freedom in time chart creation can be significantly increased.

When a checkbox (35c) in the window 35 is checked, the output of the output unit for which an output-associated setting has been set is inverted with respect to the signal of the input unit or the output unit that is the output association source. This window 35 is an example of an output-associated setting unit realized by the input reception unit 12a.

According to this embodiment described above, by inputting information such as a travel distance of a slider and other mechanical elements, a time chart indicating the velocity transitions of the mechanical elements is automatically created. This time chart is converted into control data that can be interpreted and executed by the controller 100. Consequently, only by inputting the intuitive information of the travel distance of the mechanical element, the user can cause a mechanical element to perform an operation in which the movement velocity gradually increases and subsequently gradually decreases.

Moreover, although in the above description, a slider, which is a mechanical element that has a linear motion, is given as an example to simplify the description, this disclosure can be similarly applied even for a mechanical element that has a rotary motion.

A time chart creation apparatus according to an embodiment of the present invention includes: a travel distance reception unit which receives an input of a travel distance of a mechanical element; a time chart calculation unit which calculates, based on the travel distance, a time chart that includes a velocity transition in which a movement velocity of the mechanical element gradually increases and/or gradually decreases; a control data output unit which outputs control data for controlling the mechanical element based on the time chart; and an acceleration/deceleration time reception unit which receives an input of an acceleration time and/or a deceleration time of the mechanical element, and/or an acceleration/deceleration rate reception unit which receives an input of an acceleration rate and/or a deceleration rate of the mechanical element. The time chart calculation unit calculates the time chart based on the travel distance and one or more of the acceleration time, the deceleration time, the acceleration rate, and the deceleration rate.

The time chart calculation unit may selectively calculates, based on the travel distance, a first time chart for causing the mechanical element to perform at least an acceleration operation, a constant-velocity operation, and a deceleration operation, and a second time chart for causing the mechanical element to perform an operation of shifting to deceleration after acceleration.

The time chart calculation unit may calculate, when calculating the second time chart, a time chart in which the acceleration time and/or the deceleration time is reflected as an operation of the mechanical element.

The time chart calculation unit may calculate, when calculating the second time chart, a time chart in which the acceleration rate and/or the deceleration rate is reflected as an operation of the mechanical element.

The time chart calculation unit may be capable of selecting, when calculating the second time chart, a time chart in which the acceleration time and/or the deceleration time is reflected as an operation of the mechanical element, and a time chart in which the acceleration rate and/or the deceleration rate is reflected as the operation of the mechanical element.

The time chart creation apparatus may further include: an input change timing reception unit which receives a timing at which a change occurs in an input from an input unit; and an association reception unit which receives an input of an association between a timing at which a change occurs in an input from the input unit and a timing at which the mechanical element indicated by the time chart starts to move, and the control data output unit may output control data for causing the mechanical element to start to move when the input of an association is received under a condition that a change in an input from the input unit occurs.

The time chart creation apparatus may further include an output-associated setting unit which sets so that an output to a specific output unit changes in association with an input signal from an arbitrary input unit and/or an output signal to an arbitrary output unit.

The output-associated setting unit may set whether to invert the output to the specific output unit with respect to the input signal and/or the output signal.

The time chart creation apparatus may further include a maximum velocity reception unit which receives an input of a maximum velocity of the mechanical element, and the time chart calculation unit may set a velocity of the mechanical element in the constant-velocity operation as the maximum velocity when calculating the first time chart.

A controller according to an embodiment of the present invention controls a mechanical element by executing a time chart created by the above-mentioned time chart creation apparatus.

A mechanical element control system according to an embodiment of the present invention includes: the above-mentioned controller; and a mechanical element that is connected to the controller so that the mechanical element is controllable by the controller.

A method of creating a time chart according to an embodiment of the present invention includes: receiving an input of a travel distance of a mechanical element; calculating, based on the travel distance, a time chart that includes a velocity transition in which a movement velocity of the mechanical element gradually increases or gradually decreases; outputting control data for controlling the mechanical element based on the time chart; and receiving an input of an acceleration time and/or a deceleration time of the mechanical element, and/or an acceleration rate and/or a deceleration rate of the mechanical element. The calculating of the time chart is carried out based on the travel distance and one or more of the acceleration time, the deceleration time, the acceleration rate, and the deceleration rate.

A computer-readable information storage medium according to an embodiment of the present invention has a program for causing a computer to function as: a travel distance reception unit which receives an input of a travel distance of a mechanical element; a time chart calculation unit which calculates, based on the travel distance, a time chart that includes a velocity transition in which a movement velocity of the mechanical element gradually increases or gradually decreases; a control data output unit which outputs control data for controlling the mechanical element based on the time chart; and an acceleration/deceleration time reception unit which receives an input of an acceleration time and/or a deceleration time of the mechanical element, and/or an acceleration/deceleration rate reception unit which receives an input of an acceleration rate and/or a deceleration rate of the mechanical element. The time chart calculation unit calculates the time chart based on the travel distance and one or more of the acceleration time, the deceleration time, the acceleration rate, and the deceleration rate.

Obviously, numerous modifications and variations of the present invention are possible in light of the above teachings. It is therefore to be understood that within the scope of the appended claims, the invention may be practiced otherwise than as specifically described herein.

What is claimed is:

1. A time chart creation apparatus for providing control data to a machine control system controlling an operation conversion apparatus, comprising:
circuitry configured to
receive an input of a travel distance of a mechanical element of the operation conversion apparatus,
receive an input of at least one of an acceleration time, a deceleration time, an acceleration rate and a deceleration rate of the mechanical element of the operation conversion apparatus,
calculate a time chart based on the travel distance and at least one of the acceleration time, the deceleration time, the acceleration rate and the deceleration rate such that the time chart includes a velocity transition of the mechanical element of the operation conversion apparatus, and
output the control data to the machine control system, which controls the mechanical element of the operation conversion apparatus based on the time chart represented in the control data.

2. The time chart creation apparatus according to claim 1, wherein the circuity is further configured to selectively calculate a first time chart for an acceleration operation, a constant-velocity operation, and a deceleration operation based on the travel distance, and a second chart for an operation of shifting to deceleration after acceleration based on the travel distance.

3. The time chart creation apparatus according to claim 2, wherein the second time chart reflects at least one of the acceleration time and the deceleration time.

4. The time chart creation apparatus according to claim 2, wherein the second time chart reflects at least one of the acceleration rate and the deceleration rate.

5. The time chart creation apparatus according to claim 2, wherein the circuitry is configured to select the second time chart from a one of a time chart that reflects at least one of the acceleration time and the deceleration time and a time chart that reflects at least one of the acceleration rate and the deceleration rate.

6. The time chart creation apparatus according to claim 1, wherein the circuitry is further configured to:
receive a timing at which a change occurs in an input,
receive an input of an association between the timing at which the change occurs in the input and a timing at which the mechanical element of the operation conversion apparatus starts to move based on the time chart,
update the control data based on the association, and
output the control data to the machine control system which causes the mechanical element of the operation conversion apparatus to start to move.

7. The time chart creation apparatus according to claim 1, wherein the circuitry is further configured to set an output to a specific output such that the output to the specific output is changed in association with at least one of an input signal from an arbitrary input and an output signal to an arbitrary output.

8. The time chart creation apparatus according to claim 7, wherein the circuity is further configured to set whether to invert the output to the specific output with respect to at least one of the input signal and the output signal.

9. The time chart creation apparatus according to claim 2, wherein the circuitry is further configured to
receive an input of a maximum velocity of the mechanical element of the operation conversion apparatus, and
set a velocity of the mechanical element of the operation conversion apparatus in the constant-velocity operation to the maximum velocity when calculating the first time chart.

10. The time chart creation apparatus according to claim 1, wherein the input of the travel distance of the mechanical element of the operation conversion apparatus is a user input received via a user interface.

11. The time chart creation apparatus according to claim 1, wherein the input of at least one of the acceleration time, the deceleration time, the acceleration rate, and the deceleration rate of the mechanical element of the operation conversion apparatus is a user input received via a user interface.

12. The time chart creation apparatus according to claim 1, wherein the circuitry is further configured to
receive an input of each of an acceleration time and a deceleration time of the mechanical element of the operation conversion apparatus, and
calculate a time chart based on the travel distance and at each of the acceleration time and the deceleration time such that the time chart includes the velocity transition of the mechanical element of the operation conversion apparatus.

13. The time chart creation apparatus according to claim 1, wherein the circuitry is further configured to receive an input of each of an acceleration rate and a deceleration rate of the mechanical element of the operation conversion apparatus, and calculate a time chart based on the travel distance and at each of the acceleration rate and the deceleration rate such that the time chart includes the velocity transition of the mechanical element of the operation conversion apparatus.

14. The time chart creation apparatus according to claim 1, wherein the circuitry is further configured to calculate the time chart by calculating a waveform, the waveform being calculated based on the travel distance and at least one of the acceleration time, the deceleration time, the acceleration rate, and the deceleration rate.

15. The time chart creation apparatus according to claim 14, wherein the waveform is calculated by comparing the travel distance against a second travel distance calculated based on at least one of the acceleration time, the deceleration time, the acceleration rate, and the deceleration rate, such that when the travel distance is larger than the second travel distance, the waveform generated has a trapezoidal shape and when the travel distance is smaller than the second travel distance, the waveform has a triangular shape.

16. The time chart creation apparatus according to claim 1, wherein the circuitry is further configured to receive a selection between a group of acceleration time and deceleration time and a group of acceleration rate and deceleration rate, for calculation of the time chart.

17. The machine control system for controlling the mechanical element of the operation conversion apparatus by executing the time chart created by the time chart creation apparatus according to claim 1.

18. A machine control system for controlling an operation conversion apparatus, comprising:
a controller configured to control a mechanical element of the operation conversion apparatus connected to the controller based on a time chart represented in control data,
wherein the controller is configured to receive the time chart from a time chart creation apparatus comprising circuitry configured to receive an input of a travel distance of the mechanical element of the operation conversion apparatus, receive an input of at least one of an acceleration time, a deceleration time, an acceleration rate and a deceleration rate of the mechanical element of the operation conversion apparatus, calculate the time chart based on the travel distance and at least one of the acceleration time, the deceleration time, the acceleration rate and the deceleration rate such that the time chart includes a velocity transition of the mechanical element of the operation conversion apparatus, and output the control data to the controller which controls the mechanical element of the operation conversion apparatus based on the time chart represented in the control data.

19. A method of creating a time chart for providing control data to a machine control system controlling an operation conversion apparatus, comprising:
receiving a user input of a travel distance of a mechanical element of the operation conversion apparatus;
receiving an input of at least one of an acceleration time, a deceleration time, an acceleration rate and a deceleration rate of the mechanical element of the operation conversion apparatus;
calculating a time chart based on the travel distance and at least one of the acceleration time, the deceleration time, the acceleration rate and the deceleration rate such that the time chart includes a velocity transition of the mechanical element of the operation conversion apparatus; and
outputting the control data to the machine control system that controls the mechanical element of the operation conversion apparatus based on the time chart represented in the control data.

20. A non-transitory computer readable medium having stored thereon a program that when executed by a computer causes the computer to execute a method of creating a time chart for providing control data to a machine control system controlling an operation conversion apparatus, comprising:
receiving an input of a travel distance of a mechanical element of the operation conversion apparatus;
receiving an input of at least one of an acceleration time, a deceleration time, an acceleration rate and a deceleration rate of the mechanical element of the operation conversion apparatus;
calculating a time chart based on the travel distance and at least one of the acceleration time, the deceleration time, the acceleration rate and the deceleration rate such that the time chart includes a velocity transition of the mechanical element of the operation conversion apparatus; and
outputting the control data to the machine control system that controls the mechanical element of the operation conversion apparatus based on the time chart represented in the control data.
